(19) United States
(12) Patent Application Publication
(10) Pub. No.: US 2015/0339594 A1
(43) Pub. Date: Nov. 26, 2015

(54) EVENT MANAGEMENT FOR A SENSOR BASED DETECTON SYSTEM

(71) Applicants: Allied Telesis Holdings Kabushiki Kaisha, Tokyo (JP); ALLIED TELESIS, INC., Bothell, WA (US)

(72) Inventors: Joseph L. Gallo, Santa Cruz, CA (US); Ferdinand E.K. de Antoni, Manila (PH); Scott Gill, Makati (PH); Daniel Stellick, Geneva, IL (US)

(73) Assignees: Allied Telesis Holdings Kabushiki Kaisha, Tokyo (JP); ALLIED TELESIS, INC., Bothell, WA (US)

(21) Appl. No.: 14/281,904

(22) Filed: May 20, 2014

(51) Int. Cl. G06Q 10/02; G06F 17/30

(52) U.S. Cl. CPC G06Q 10/02; G06F 17/30864

(57) ABSTRACT

Provided is a method including receiving data associated with at least one radiation detection sensor reading. The method also includes in response to the received data satisfying a certain condition, generating an event ticket; and assigning the event ticket to a first entity for processing.

### RELATED APPLICATIONS

This application is related to U.S. patent application Se. No. ______ entitled “SENSOR BASED DETECTION SYSTEM”, by Joseph L. Gallo et al. (Attorney Docket No. 13-12-00-US) and filed concurrently herewith on ______ and incorporated by reference herein.

This application is related to U.S. patent application Ser. No. ______ entitled “SENSOR MANAGEMENT AND SENSOR ANALYTICS SYSTEM”, by Joseph L. Gallo et al. (Attorney Docket No. 13-13-00-US) and filed concurrently herewith on ______ and incorporated by reference herein.

### BACKGROUND

As technology has advanced, computing technology has proliferated to an increasing number of areas while decreasing in price. Consequently, devices such as smartphones, laptops, GPS, etc., have become prevalent in our community, thereby increasing the amount of data being gathered in an ever increasing number of locations. Unfortunately, most of the gathered information is used for marketing and advertising to the end user, e.g., smartphone user receives a coupon to a nearby coffee shop, etc., while the security of our community is left exposed and at a risk of terrorist attacks such as the Boston Marathon bombers.

### SUMMARY

Accordingly, a need has arisen for a solution to allow monitoring and collection of data from a plurality of sensors and management of the plurality of sensors for improving security of our communities, e.g., by detecting radiation, etc. Further, there is a need to provide relevant information based on the sensors in an efficient manner to increase security.

Provided is a method that includes receiving data associated with at least one radiation detection sensor reading. The method also includes in response to the received data satisfying a certain condition, generating an event ticket. The method also includes assigning the event ticket to a first entity for processing.

Provided herein is a system including an event module configured to generate an event based on alerts associated with one more radiation detection sensor reading. The system also includes an event ticket module configured to receive the generated event. The event ticket module is further configured to generate an event ticket responsive to the event satisfying a certain condition. The event ticket module is further configured to assign the generated event ticket to an appropriate entity for processing. The system also includes an event ticket collection module configured to receive and store the generated event ticket for later retrieval.

Provided is a method that includes receiving data associated with a sensor reading from at least one sensor. The method also includes generating an event ticket in response to the received data exceeding a certain condition. The event ticket includes information associated with an event ticket identifier, sensor data, status of the event ticket, or any combination thereof. The method also includes assigning the event ticket to a first entity for processing. The method also includes reassigning the generated ticket from the first entity to a second entity based on a pendency of the generated event ticket or on actions taken with respect to the generated event ticket. The method also includes transmitting a message to the second entity indicating that the generated event ticket is awaiting for processing.

These and other features and aspects may be better understood with reference to the following drawings, description, and appended claims.

### BRIEF DESCRIPTION OF DRAWINGS

FIG. 1 illustrates an exemplary operating environment according to one embodiment.

FIG. 2 illustrates exemplary components of the sensor based detection system of FIG. 1 according to one embodiment.

FIG. 3 illustrates an exemplary event management system according to one embodiment.

FIG. 4 illustrates an exemplary wireframe of a graphical user interface (GUI) for event ticket log according to one embodiment.

FIGS. 5-7 illustrate exemplary wireframes of a GUI for an event ticket according to some embodiments.

FIG. 8 illustrates one exemplary flow chart overview to manage an event ticket according to some embodiments.

FIG. 9 illustrates another exemplary flow chart overview to manage an event ticket, according to some embodiments.

FIG. 10 illustrates an exemplary computer system, according to one embodiment.

FIG. 11 illustrates a block diagram of another exemplary computer system, according to some embodiments.

### DETAILED DESCRIPTION

Reference will now be made in detail to various embodiments, examples of which are illustrated in the accompanying drawings. While the claimed embodiments will be described in conjunction with various embodiments, it will be understood that these various embodiments are not intended to limit the scope of the embodiments. On the contrary, the claimed embodiments are intended to cover alternatives, modifications, and equivalents, which may be included within the scope of the appended Claims. Furthermore, in the following detailed description, numerous specific details are set forth in order to provide a thorough understanding of the claimed embodiments. However, it will be evident to one of ordinary skill in the art that the claimed embodiments may be practiced without these specific details. In other instances, well known methods, procedures, components, and circuits are not described in detail so that aspects of the claimed embodiments are not obscured.

Some portions of the detailed descriptions that follow are presented in terms of procedures, logic blocks, processing, and other symbolic representations of operations on data bits within a computer memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “generating,” “assigning,” “determining,” “transmitting,” “tracking,” “modifying,” “escalating,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Provided herein are embodiments for managing an escalation workflow for events captured by a sensor-based system. For example, the sensor-based system include any of a variety of sensors including thermal sensors (e.g., temperature, heat, etc.), electromagnetic sensors (e.g., metal detectors, light sensors, particle sensors, Geiger counter, charge-coupled device (CCD), etc.), mechanical sensors (e.g. tachometer, odometer, etc.), biological/chemical (e.g., toxins, nutrients, etc.), or any combination thereof. The sensor-based system may further include any of a variety of sensors or a combination thereof including, but not limited to, acoustic, sound, vibration, automotive/transportation, chemical, electrical, magnetic, radio, environmental, weather, moisture, humidity, flow, fluid velocity, ionizing, atomic, subatomic, navigational, position, angle, displacement, distance, speed, acceleration, optical, light imaging, photon, pressure, force, density, level, thermal, heat, temperature, proximity, presence, radiation, Geiger counter, crystal-based portal sensors, biochemical, pressure, air quality, water quality, fire, flood, intrusion detection, motion detection, particle count, water level, or surveillance cameras. In some embodiments, the escalation workflow may be implemented using “tickets” associated with an event and by monitoring the status of the event based on either in real-time or recorded data. Herein, reference to an event may refer to a grouping of occurrences when a value of data from a number of related sensors is above a pre-determined threshold over a period of time value, the value is within a certain range, etc. The grouping of sensors may be based on various conditions, e.g., proximity of sensors to one another, geo-location of the sensors and their particular location, type of sensor, range of sensor detection, physical proximity of sensors, floor plan of a structure where the sensor is positioned or is next to, etc. Furthermore, herein, reference to an event ticket may refer to a data object associated with a particular event of a sensor or a group of sensors that may include an associated status of the event ticket (e.g., open, closed, etc.) and other relevant data, such as metadata associated with the sensors. In some embodiments, the system for managing the escalation workflow may provide functionality to alert appropriate entities or individuals to the status of events captured by the sensor-based system as events evolve, either in real-time or based on recorded sensor data.

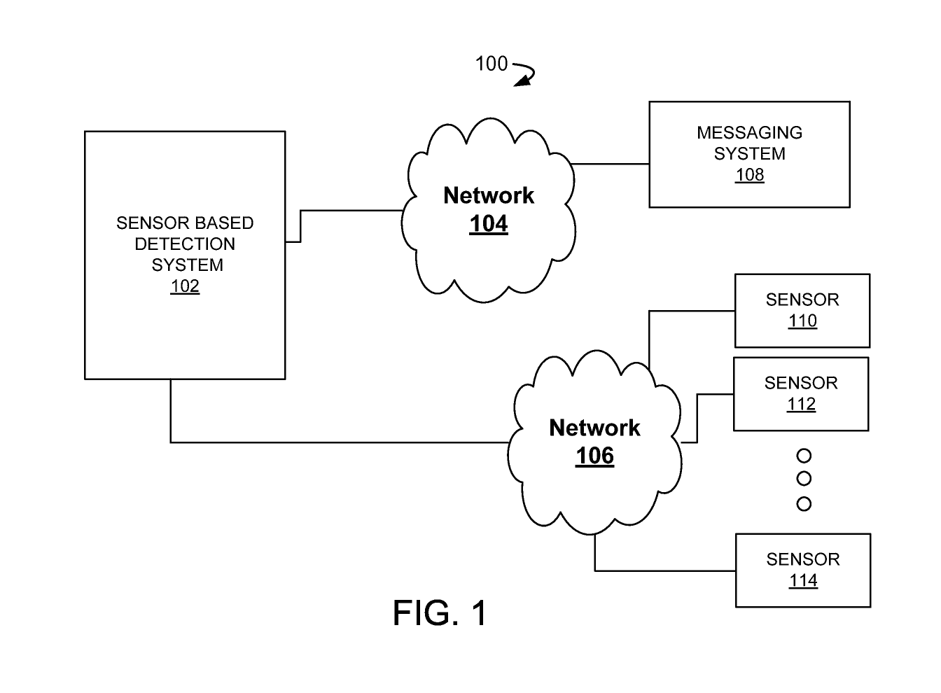

FIG. 1 shows an exemplary operating environment in accordance with one embodiment. Exemplary operating environment 100 includes a sensor based detection system 102, a network 104, a network 106, a messaging system 108, and sensors 110-114. The sensor based detection system 102 and the messaging system 108 are coupled to a network 104. The sensor based detection system 102 and messaging system 108 are communicatively coupled via the network 104. The sensor based detection system 102 and sensors 110-114 are coupled to a network 106. The sensor based detection system 102 and sensors 110-114 are communicatively coupled via network 106. Networks 104, 106 may include more than one network (e.g., intranets, the Internet, local area networks (LAN)s, wide area networks (WAN)s, etc.) and may be a combination of one or more networks including the Internet. In some embodiments, network 104 and network 106 may be a single network.

The sensors 110-114 detect a reading associated therewith, e.g., gamma radiation, vibration, etc., and transmit that information to the sensor based detection system 102 for analysis. The sensor based detection system 102 may use the received information and compare it to a threshold value, e.g., historical values, user selected values, etc., in order to determine whether a potentially hazardous event has occurred. In response to the determination, the sensor based detection system 102 may transmit that information to the messaging system 108 for appropriate action, e.g., emailing the appropriate personnel, sounding an alarm, tweeting an alert, alerting the police department, alerting homeland security department, etc. Accordingly, appropriate actions may be taken in order to avert the risk.

The sensors 110-114 may be any of a variety of sensors including thermal sensors (e.g., temperature, heat, etc.), electromagnetic sensors (e.g., metal detectors, light sensors, particle sensors, Geiger counter, charge-coupled device (CCD), etc.), mechanical sensors (e.g. tachometer, odometer, etc.), complementary metal-oxide-semiconductor (CMOS), biological/chemical (e.g., toxins, nutrients, etc.), etc. The sensors 110-114 may further be any of a variety of sensors or a combination thereof including, but not limited to, acoustic, sound, vibration, automotive/transportation, chemical, electrical, magnetic, radio, environmental, weather, moisture, humidity, flow, fluid velocity, ionizing, atomic, subatomic, navigational, position, angle, displacement, distance, speed, acceleration, optical, light imaging, photon, pressure, force, density, level, thermal, heat, temperature, proximity, presence, radiation, Geiger counter, crystal based portal sensors, biochemical, pressure, air quality, water quality, fire, flood, intrusion detection, motion detection, particle count, water level, surveillance cameras, etc. The sensors 110-114 may be video cameras (e.g., internet protocol (IP) video cameras) or purpose built sensors.

The sensors 110-114 may be fixed in location (e.g., surveillance cameras or sensors), semi-fixed (e.g., sensors on a cell tower on wheels or affixed to another semi portable object), or mobile (e.g., part of a mobile device, smartphone, etc.). The sensors 110-114 may provide data to the sensor based detection system 102 according to the type of the sensors 110-114. For example, sensors 110-114 may be CMOS sensors configured for gamma radiation detection. Gamma radiation may thus illuminate a pixel, which is converted into an electrical signal and sent to the sensor based detection system 102.

The sensor based detection system 102 is configured to receive data and manage sensors 110-114. The sensor based detection system 102 is configured to assist users in monitoring and tracking sensor readings or levels at one or more locations. The sensor based detection system 102 may have various components that allow for easy deployment of new sensors within a location (e.g., by an administrator) and allow for monitoring of the sensors to detect events based on user preferences, heuristics, etc. The events may be used by the messaging system 108 to generate sensor-based alerts (e.g., based on sensor readings above a threshold for one sensor, based on the sensor readings of two sensors within a certain proximity being above a threshold, etc.) in order for the appropriate personnel to take action. The sensor based detection system 102 may receive data and manage any number of sensors, which may be located at geographically disparate locations. In some embodiments, the sensors 110-114 and components of a sensor based detection system 102 may be distributed over multiple systems (e.g., and virtualized) and a large geographical area.

The sensor based detection system 102 may track and store location information (e.g., board room B, floor 2, terminal A, etc.) and global positioning system (GPS) coordinates, e.g., latitude, longitude, etc. for each sensor or group of sensors. The sensor based detection system 102 may be configured to monitor sensors and track sensor values to determine whether a defined event has occurred, e.g., whether a detected radiation level is above a certain threshold, etc., and if so then the sensor based detection system 102 may determine a route or path of travel that dangerous or contraband material is taking around or within range of the sensors. For example, the path of travel of radioactive material relative to fixed sensors may be determined and displayed via a graphical user interface. It is appreciated that the path of travel of radioactive material relative to mobile sensors, e.g., smartphones, etc., or relative to a mixture of fixed and mobile sensors may similarly be determined and displayed via a graphical user interface. It is appreciated that the analysis and/or the sensed values may be displayed in real-time or stored for later retrieval.

The sensor based detection system 102 may display a graphical user interface (GUI) for monitoring and managing sensors 110-114. The GUI may be configured for indicating sensor readings, sensor status, sensor locations on a map, etc. The sensor based detection system 102 may allow review of past sensor readings and movement of sensor detected material or conditions based on stop, play, pause, fast forward, and rewind functionality of stored sensor values. The sensor based detection system 102 may also allow viewing of image or video footage corresponding to sensors that had sensor readings above a threshold (e.g., based on a predetermined value or based on ambient sensor readings). For example, a sensor may be selected in a GUI and video footage associated with an area within a sensor's range of detection may be displayed, thereby enabling a user to see an individual transporting hazardous material. According to one embodiment the footage is displayed in response to a user selection or it may be displayed automatically in response to a certain event, e.g., sensor reading associated with a particular sensor or group of sensors being above a certain threshold.

In some embodiments, sensor readings of one or more sensors may be displayed on a graph or chart for easy viewing. A visual map-based display depicting sensors may be displayed with the sensors color coded according to the sensors' readings and certain events. For example, gray may be associated with a calibrating sensor, green may be associated with a normal reading from the sensor, yellow may be associated with an elevated sensor reading, orange associated with a potential hazard sensor reading, and red associated with a hazard alert sensor reading.

The sensor based detection system 102 may determine alerts or sensor readings above a specified threshold (e.g., predetermined, dynamic, or ambient based) or based on heuristics and display the alerts in the graphical user interface (GUI). The sensor based detection system 102 may allow a user (e.g., operator) to group multiple sensors together to create an event associated with multiple alerts from multiple sensors. For example, a code red event may be created when three sensors or more within twenty feet of one another and within the same physical space have a sensor reading that is at least 40% above the historical values. In some embodiments, the sensor based detection system 102 may automatically group sensors together based on geographical proximity of the sensors, e.g., sensors of gates 1, 2, and 3 within terminal A at LAX airport may be grouped together due to their proximate location with respect to one another, e.g., physical proximity within the same physical space, whereas sensors in different terminals may not be grouped because of their disparate locations. However, in certain circumstances sensors within the same airport may be grouped together in order to monitor events at the airport and not at a more granular level of terminals, gates, etc.

The sensor based detection system 102 may send information to a messaging system 108 based on the determination of an event created from the information collected from the sensors 110-114. The messaging system 108 may include one or more messaging systems or platforms which may include a database (e.g., messaging, SQL, or other database), short message service (SMS), multimedia messaging service (MMS), instant messaging services, Twitter™ available from Twitter, Inc. of San Francisco, Calif., Extensible Markup Language (XML) based messaging service (e.g., for communication with a Fusion center), JavaScript™ Object Notation (JSON) messaging service, etc. For example, national information exchange model (NIEM) compliant messaging may be used to report chemical, biological, radiological and nuclear defense (CBRN) suspicious activity reports (SARs) to report to government entities (e.g., local, state, or federal government).

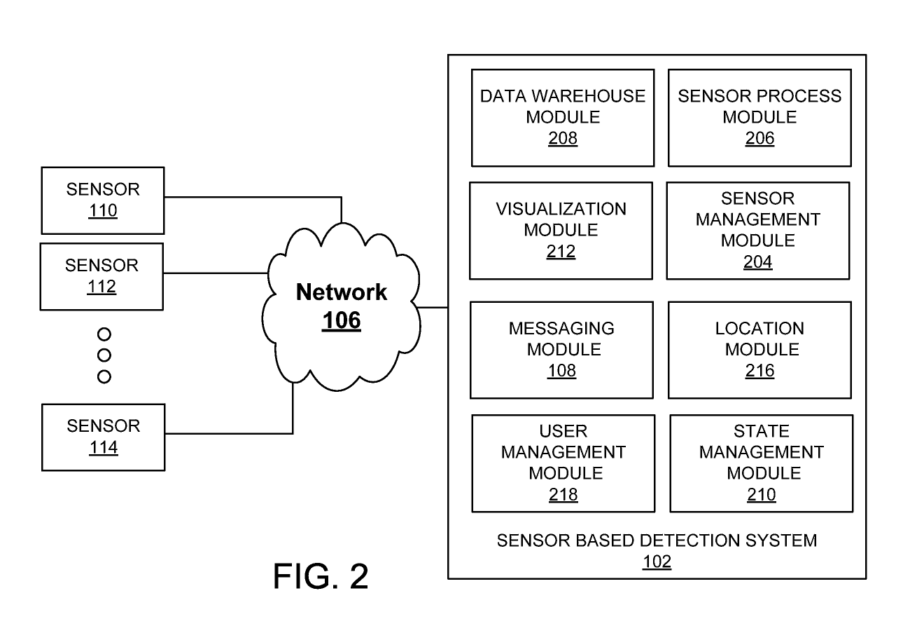

FIG. 2 shows exemplary components of a sensor based detection system in accordance with one embodiment. Diagram 200 includes sensors 110-114, a network 230, and a sensor based detection system 102. As described above, sensor based detection system 102 and sensors 110-114, and 120 are coupled to a network 160. The network 160 may include more than one network (e.g., intranets, the Internet, LANs, WANs, etc.) and may be a combination of one or more networks including the Internet.

The sensor based detection system 102 may access or receive data from the sensors 110-114. The sensor based detection system 102 may include a sensor management module 204, a sensor process module 206, a data warehouse module 208, a state management module 210, a visualization module 212, a messaging module 108, a location module 216, and a user management module 218.

In some embodiments, the sensor based detection system 102 may be distributed over multiple servers (e.g., physical or virtual machines). For example, a domain server may execute the data warehouse module 208 and the visualization module 212, a location server may execute the sensor management module 204 and one or more instances of a sensor process module 206, and a messaging server may execute the messaging module 108. For example, multiple location servers may each be located at respective sites having 100 sensors, and provide analytics to a single domain server, which provides a monitoring and management interface (e.g., GUI) and messaging services. The domain server may be centrally located while the location servers may be located proximate to the sensors for bandwidth purposes.

The sensor management module 204 is configured to monitor and manage the sensors 110-114. The sensor management module 204 is configured to initiate one or more instances of sensor process module 206 for monitoring and managing sensors 110-114. The sensor management module 204 is operable to configure a new sensor process (e.g., an instance of sensor process module 206) when a new sensor is installed. The sensor management module 204 may thus initiate execution of multiple instances of the sensor process module 206. In some embodiments, an instance of the sensor process module 206 is executed for each sensor. For example, if there are 50 sensors, 50 instances of sensor process module 206 are executed in order to configure the sensors. It is further appreciated that the sensor management module 204 may also be operable to configure an already existing sensor. For example, sensor 110 may have been configured previously, however, the sensor management module 204 may reconfigure sensor 110 based on the new configuration parameters. The sensor management module 204 may be configured as an aggregator and collector of data from the sensors 110-114 via sensor process module 206. Sensor management module 204 is configured to send data received via instances of sensor process module 206 to a data warehouse module 208.

The sensor management module 204 further allows monitoring of one or more instances of the sensor process module 206 to determine whether an instance of the sensor process module 206 is running properly or not. In some embodiments, the sensor management module 204 is configured to determine the health of one or more sensors including if a sensor has failed based on whether an anticipated or predicted value is received within a certain time period. The sensor management module 204 may further be configured to determine whether data is arriving on time and whether the data indicates that the sensor is functioning properly (e.g. healthy) or not. For example, a radiation sensor may be expected to provide a certain microsievert (mSv) value within a given time period. In some embodiments, the anticipated value may be received from an analytics engine that analyzes the sensor data. In some embodiments, the sensor management module 204 may be configured to receive an indicator of status from a sensor (e.g., an alive signal, an error signal, or an on/off signal). The health information may be used for management of the sensors 110-114 and the health information associated with the sensors may be stored in the data warehouse 208.

The sensor management module 204 may further access and examine the outputs from the sensors based on a predictable rate of output. For example, an analytics process (e.g., performed by the sensor process module 206) associated with a sensor may produce a record every ten seconds and if a record is not received (e.g., within multiple 10 second periods of time), the sensor management module 204 may stop and restart the analytics process. In some embodiments, the record may be a flat file.

The sensor process module 206 is configured to receive data (e.g., bulk or raw data) from sensors 110-114. In some embodiments, the sensor process module 206 may form a record (e.g. a flat file) based on the data received from the sensors 110-114. The sensor process module 206 may perform analysis of the raw data (e.g., analyze frames of video to determine sensor readings). In some embodiments, the sensor process module 206 may then pass the records to the sensor management module 204.

The data warehouse module 208 is configured to receive data from sensor management module 204. The data warehouse module 208 is configured for storing sensor readings and metadata associated with the sensors. Metadata for the sensors may include their respective geographical information (e.g., GPS coordinates, latitude, longitude, etc.), description of the sensor, e.g., sensor at gate 1 terminal A at LAX, etc. In some embodiments, the data warehouse module 208 may be configured to determine state changes based on monitoring (e.g., real time monitoring) of the state of each sensor and the state of the sensor over a time interval (e.g., 30 seconds, 1 minute, 1 hour, etc.). In some embodiments, the data warehouse module 208 is configured to generate an alert (e.g., when a sensor state has changed and is above a threshold, when a sensor reading satisfies a certain condition such as being below a threshold, etc.). The generated alert may be sent to visualization module 212 for display (e.g., to a user). Changes in sensor state may thus be brought to the attention of a user (e.g., operator). It is appreciated that the threshold values may be one or more historical values, safe readings, operator selected values, etc.

In some embodiments, the data warehouse module 208 may be implemented in a substantially similar manner as described in Philippines Patent Application No. 1-2013-000136 entitled “A Domain Agnostic Method and System for the Capture, Storage, and Analysis of Sensor Reading”, by Ferdinand E. K. De Antoni (Attorney Docket No. 13-027-00-PH) which is incorporated by reference herein.

The state management module 210 may read data from the data warehouse module 208 and/or from the sensor management module 204 (e.g., data that was written by sensor management module 204) and determine whether a state change has occurred. The state change may be determined based on a formula to determine whether there has been a change since a previous record in time for an associated sensor and may take into account ambient sensor readings. If there is a change in state, an alert may be triggered. It is appreciated that state may also be a range of values. One or more alerts may be assembled (e.g., into a data structure) referred to as an event. The event may then be accessed by or sent to a visualization module 212. The visualization module 212 may then display the change in state, an alert, or an event. In some embodiments, the visualization module 212 may receive input to have the alert sent to an external system (e.g., a messaging system).

The visualization module 212 is configured for use in monitoring a location for potential sensor based alerts. The visualization module 212 may provide a graphical user interface (GUI) to monitor and manage each of the deployed sensors. In some embodiments, the visualization module 212 is configured to provide a tree filter to view each of the sensors in a hierarchical manner, as well as a map view, thereby allowing monitoring of each sensor in a geographical context. The visualization module 212 may further allow creation of an event case file to capture sensor alerts at any point in time and escalate the sensor alert to appropriate authorities for further analysis (e.g., via a messaging system). The visualization module 212 may display a path of travel or route of hazardous materials or conditions based on sensor readings and the associated sensor locations. The visualization module 212 may further be used to zoom in and zoom out on a group of sensors, e.g., sensors within a terminal at an airport, etc. As such, the information may be displayed as granular as desired by the operator. Visualization module 212 may also be used and render information in response to a user manipulation. For example, in response to a user selection of a sensor, e.g., sensor 110, the sensor readings associated with the sensor may be displayed. In another example, a video feed associated with the sensor may also be displayed (e.g., simultaneously).

The messaging module 108 is configured to send messages to other systems or messaging services including, but not limited to, a database (e.g., messaging, SQL, or other database), short message service (SMS), multimedia messaging service (MMS), instant messaging services, Twitter available from Twitter, Inc. of San Francisco, Calif., Extensible Markup Language (XML) based messaging service (e.g., for communication with a Fusion center), JavaScript Object Notation (JSON) messaging service, etc. In one example, national information exchange model (NIEM) compliant messaging may be used to report chemical, biological, radiological and nuclear defense (CBRN) suspicious activity reports (SARs) to report to government entities (e.g., local, state, or federal government). In some embodiments, the messaging module 108 may send messages based on data received from the sensor management module 204. It is appreciated that the messages may be formatted to comply with the requirement/standards of the messaging service used. For example, as described above a message may be formed into the NIEM format in order to report a CBRN event.

The location module 216 is configured for mapping and spatial analysis (e.g., triangulation) in order to graphically represent the sensors within a location. For example, location module 216 may be configured to facilitate display of the location of and associated icons for sensors at each gate of an airport terminal. In some embodiments, the sensor management module 204 is configured to store geographical data associated with a sensor in a data store (not shown) associated with location module 216. In some embodiments, the location module 216 may operate in conjunction with ArcGIS from ERSI, Inc. of Redlands, Calif. It is appreciated that the location module 216 may be used to provide mapping information associated with the sensor location such that the location of the sensor may overlay the map, e.g., location of the sensor may overlay the map of LAX airport, etc.

The user management module 218 is configured for user management and storage of user identifiers of operators and administrators. The user management portion may be integrated with an existing user management systems (e.g., OpenLDAP or Active Director) thereby enabling use of existing user accounts to operate sensor the based detection system 202.

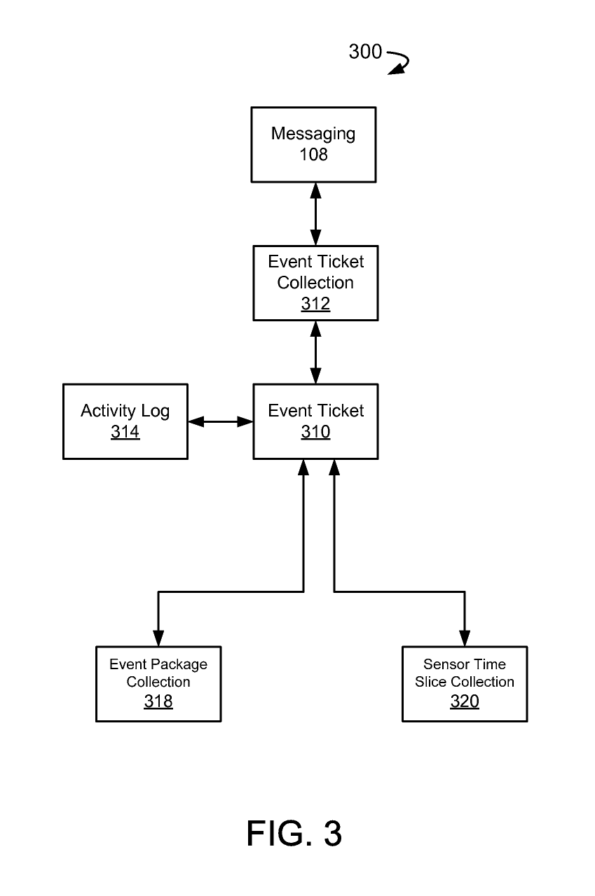

FIG. 3 illustrates an exemplary event management system, according to one embodiment. In some embodiments, event management system 300 may be included as part of one or more modules of sensor based detection system 102, such as for example state management module 218 or visualization module 208 described above. In other embodiments, event management system 300 may be implemented as a standalone system separate from sensor based detection system 102, and access one or more modules of sensor based detection system 102 in order to manage sensor events. Event management system 300 may include an event ticket module 310, events ticket collection module 312, events package collection module 318, and sensor time slice collection module 320. Although this disclosure describes and illustrates an exemplary event management system implemented through an exemplary configuration of components having exemplary functionality, this disclosure contemplates any suitable event management system implemented through any suitable configuration of any suitable components having any suitable functionality.

Event tickets may be generated by the event ticket 310 module receiving information from an event package collection module 318, sensor time slice collection module 320, activity log module 314, metadata 316, or any combination thereof. In some embodiments, event ticket module 310 may receive sensor data measured over a period of time and metadata such as its location from sensor time slice collection module 320, activity information (e.g. steps taken to address an event) from activity log module 314, and identifier information of an adjudication package that has been created with data of an event from event package module 318. It is appreciated that event tickets may be generated from events that are determined manually (e.g., by an operator), automatically by sensor based detection system 102 through heuristics, or any combination thereof. In some embodiments, an analytics process of sensor process module 206, described above, may heuristically generate events based on data stored in data warehouse module 204. The generated event tickets may be stored in the event tickets collection 312 module and it may be retrieved subsequent to the storing.

As an example, an event ticket may be generated in response to one or more radiation sensors 110-114 in a building detecting radiation above a certain value. In one instance, the reading of the one or more radiation sensors 110-114 may show a slightly elevated reading, e.g., within a first range, that may trigger generation of an event ticket for an administrator that may include information regarding the sensor reading along with additional relevant information, e.g., video footage, geographical position, etc., have been logged for further review and processing at a later date. In another instance, the reading of the one or more radiation sensors may show a highly elevated reading, e.g., completely outside of the acceptable range, which may trigger generation of an event ticket to notify the appropriate personnel, e.g., hazmat team, to immediately attend to a possible radiation leak and to further notify 911 and other agencies. In yet another instance, generation of an event ticket may initiate review of video surveillance data from image sensors in proximity to the radiation sensors that generated the event ticket (e.g., trigger the storage of video footage from image sensors within the vicinity of the radiation sensors that caused the event ticket to be generated in order for the video surveillance to be used to identify a possible perpetrator carrying radiative material). The ranges (e.g. first or acceptable) may be user selected range of sensor reading values, default range of sensor reading values, etc., and may be based on the type of sensor 110-114 (e.g., radiation, thermal, image, etc.).

As another example, an event ticket may be generated in response to one or more thermal sensors 110-114 in a building detecting heat markedly above an ambient heat level in conjunction with one or more smoke detectors having an elevated reading. In one instance, the reading of the one or more thermal sensors and smoke detectors 110-114 may show a slightly elevated reading, e.g., within a first range, that may trigger generation of an event ticket for an administrator that may include information regarding the sensor reading along with additional relevant information, e.g., type of sensors 110-114, geographical position, etc., have been logged for further review and processing at a later date. In another instance, the reading of the one or more thermal sensors or smoke detectors may show a highly elevated reading, e.g., completely outside of the acceptable range, which may trigger generation of an event ticket to notify the appropriate personnel, e.g., fire-fighting team, to immediately attend to a possible five alarm fire and to further notify the city fire department. In yet another instance, generation of an event ticket may initiate review of video surveillance data from image sensors in proximity to the thermal sensors and smoke detectors that generated the event ticket (e.g., trigger the storage of video footage from image sensors within the vicinity of the radiation sensors that caused the event ticket to be generated in order for the video surveillance to be used to identify a possible arsonist).

As discussed above, an event ticket may refer to a data object of an event that includes one or more types of data of the event. For example, data of the event ticket may include a unique identifier (e.g. reference number), data (e.g., readings) from sensors 110-114 associated with the event ticket, associated status information, or any combination thereof. An event ticket may have a corresponding reference number for locating the event ticket. Data from the sensors that initiated generation of the event ticket may include sensor readings, e.g., one or more readings from one or more sensors 110-114 associated with the event ticket. It is appreciated that data from sensors 110-114 may further include the analysis of the data received from sensors 110-114 that generated the event ticket (e.g., possible path taken by the hazardous material, captured surveillance footage within the proximity of the sensors that generated the event ticket, corroborating data from other types of sensors, map data showing the location of sensors 110-114 in a physical structure, etc.).

According to one embodiment, status information may include open, closed, in progress, canceled, priority level, or adjudication package (e.g. sent to particular third-party for further analysis as described below), etc., which are associated with the date/time of which the status information has been created, changed, updated, or any combination thereof, and it may further include a timestamp associated with each creation, change, or update. Open status may indicate that the event ticket is open and has not been processed. Closed status may indicate that the event ticket has been processed and closed. In progress status may indicate that the event ticket is being processed but is not yet completed. Canceled status may indicate that the event ticket has been canceled without processing. The priority level may indicate the importance or severity of the event ticket, e.g., highest priority may indicate imminent radiation/biohazard danger whereas a low priority may indicate slightly elevated radiation detection. It is appreciated that the priority level may have any number of levels of granularity as appropriate. In one embodiment, the number of priority levels may be user modifiable parameter such that in one system a user might have two priority levels whereas in a different system a might have ten or more priority levels. The event ticket may further include information regarding the status of the event, e.g., readings from radiation sensors 110-114 are still elevated, a change in radiation sensors reading has occurred, the time the event ticket is open is beyond a period of time, the person/entity currently responsible for the event ticket, activity taken in regard to the event ticket, or any combination thereof.

It is appreciated that event tickets may further include metadata that is aggregated with the event generated by the event ticket 310 module. Event ticket metadata may include information associated with the radiation sensors that have generated the event tickets, such as geo-positional information of sensors 110-114 (e.g., latitude, longitude, etc.), configuration parameters of sensors 110-114, description of sensors 110-114, relevant surveillance data, type and model of sensors 110-114, etc.

In some embodiments, an analytics process of event ticket module 310 may determine or assign the priority level of the event ticket. The priority level determination may be heuristic based or manually assigned by an appropriate person/entity. As an example, the analytics process of event ticket module 310 may be assign a high priority level to the event ticket based on readings from sensors 110-114 greatly exceeding a certain range. As another example, the analytics process of event ticket module 310 may assign a low priority level to the event ticket based on elevated reading from one sensor (e.g., 110) while other sensors (e.g., 112-114) in proximity have normal readings.

In some embodiments, an analytics process of event ticket module 310 may execute a hierarchy protocol to assign or escalate event tickets based on severity of the detection and priority of the event tickets. For example, the event ticket module 310 may assign one ticket event to a security guard whereas another event ticket may be assigned and transmitted to a hazmat team and yet another event ticket may be assigned to the police department. In other words, the event ticket module 310 identifies the appropriate personnel or entities to handle/manage the generated event ticket. For example, an event ticket corresponding to a kind of event may be assigned to an operator or level of an organizational chart of a third-party entity. In some instances, an event ticket may be assigned to different entities, or different levels of the same entity depending on specifics of the event ticket. In one example, an event ticket with a low priority level may be assigned to a private security company to investigate, while an event ticket with a high priority level may be assigned to the police department. In another example, an event ticket generated in response to detecting smoke in a non-critical area of a building may be assigned to a company security guard, while an event ticket generated in response to detecting smoke in a critical area of a building may be assigned to the company hazmat team.

Furthermore, the hierarchical protocol may track and determine the amount of time period an event ticket remains pending, which may include the amount of time it is moved from one responsible person to the next. In some embodiments, an event ticket may be considered incomplete while the event ticket status is set to the open status or is not set to closed status. According to one embodiment, the amount of time an event ticket remains pending without being addressed is tracked and it is escalated once its pendency exceeds a given threshold, e.g., user selected threshold, default threshold, etc. As an illustrative example, a level five priority event ticket may be escalated to a level six priority event ticket if its pendency without being addressed exceeds a certain threshold. In one instance, an event ticket generated in response to radiation sensors 110-114 may be escalated if its pendency exceeds 10 minutes. Furthermore, escalation of the event ticket may be further based on additional information received, e.g., increasing values of sensor readings, collaborating data from other types of sensors 110-114, path of the event moving toward more sensitive locations of a building, etc. In some embodiments, event ticket module 310 may track the status of the event tickets and changing the assignment of the event tickets based on the amount of time, pendency, input from the person/entity it was assigned to, values of sensor readings, path of the event, type of sensors 110-114, etc. Furthermore, event ticket module 310 may de-escalate or lower the priority level of event tickets based on decreasing values of sensor readings, data from other types of sensors 110-114 indicating the event is a false positive, path of the event moving away sensitive locations of a building, etc. Although this disclosure describes an exemplary hierarchical protocol for assigning responsibility for managing exemplary types of tickets based on exemplary criteria, this disclosure contemplates any suitable hierarchical protocol for assigning responsibility for managing any suitable type of tickets based on any suitable criteria.

In some embodiments, operators or appropriate personnel within a given hierarchical level of an organization may receive a message notification of the assignment or transfer of responsibility for managing an event ticket. For example, messaging module 108 may retrieve one or more event tickets stored in event ticket collection module 312 and transmit the notification of the event to the appropriate person/entity. In other embodiments, notification of an event ticket may be sent directly from event ticket module 310 through messaging module 108 without accessing event ticket collection module 312. For example, messaging module 108 may transmit an SMS message to a supervisor in response to the assignment of the event ticket by the event ticket 310 module to the supervisor. Messaging module 108 may use any of the messaging systems or platforms described above to notify the responsible operator or levels of the organization. In one instance, messaging module 108 may transmit an SMS message notifying assignment of the event ticket to the responsible personnel. If the event ticket is escalated, an adjudication package that includes a package of the event ticket information and data from the associated sensors 110-114 may be transmitted to the responsible personnel for further analysis. In some embodiments, the entity responsible for handling the event ticket may access the event tickets stored in ticket collection module 312. Alternatively, the information may be provided, as integrated information, with the event ticket, thereby eliminating the need to access the data separately. It is appreciated that the appropriate personnel may further be provided with access to data warehouse module 204 in order to obtain additional information if needed in order to manage and handle the ticket event. As an example, third-party access to event ticket data may be provided through an application programming interface (API) tool.

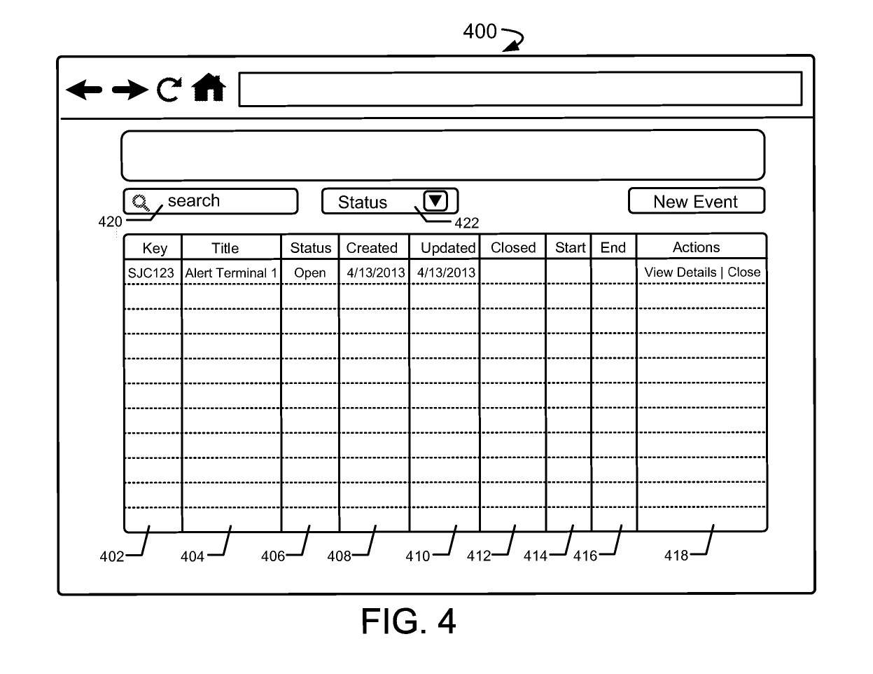

FIG. 4 illustrates an exemplary wireframe of a graphical user interface (GUI) for event ticket log according to one embodiment. In some embodiments, information associated with event tickets stored in event ticket collection module 312 may be displayed on a graphical user interface (GUI). As an example, event ticket list 400 UI may include a number of fields that each contains data associated with each event ticket. As illustrated in the example of FIG. 4, event ticket list UI 400 may include, but is not limited to, an identifier field 402, title field 404, status field 406, creation date field 408, update field 410, closing date field 412, start time field 414, end time field 416, and action field 418. As described above, data in identifier field 402, status field 406 are the unique identifier and status described in regard to FIG. 3 respectively. In some embodiments, action field 418 may include one or more graphical elements, such as for example buttons, for performing one or more pre-determined actions with regard to a particular event ticket. For example, buttons in action field 418 may display the event ticket data of the event ticket, as described in regard to FIG. 3, change the status of the event ticket to closed status, or delete the event ticket. As an example, event ticket data may be derived from data (e.g. type of sensor, location, etc.) of sensors 110-114. In some embodiments, data in start time field 414 and end time field 416 may be derived from time data associated with reading from sensors 110-114 associated with the event. For example, data in start time field 414 and end time field 416 may be data provided by sensor time slice collection module 320.

As illustrated in the example of FIG. 4, event ticket list UI 400 may also include, but is not limited to, a search field 420 and status filter 422. In some embodiments, event ticket list UI may display event tickets with at least a portion of the identifier data in identifier field 402 or title in title field 404 that corresponds to text input into search field 420. In some embodiments, event ticket list UI 400 may display event tickets with the status in status field 406 that corresponds to a type of status selected by drop-down menu of status filter 422.

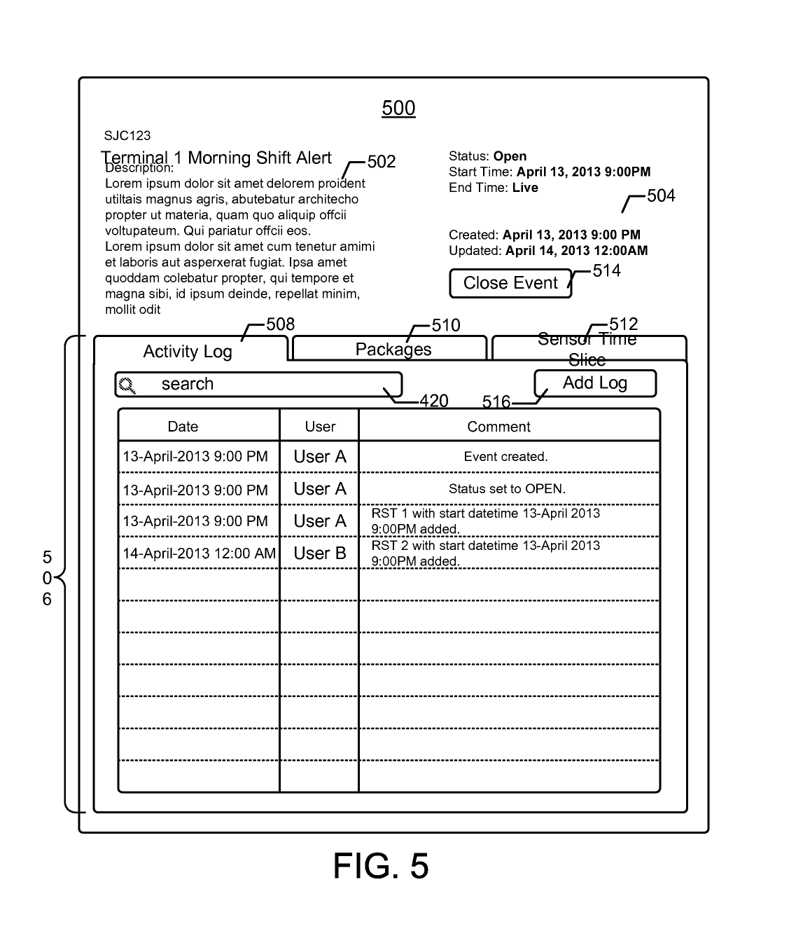

FIGS. 5-7 illustrate exemplary wireframes of a GUI for an event ticket, according to some embodiments. In some embodiments, event ticket view UI 500 may display data associated with an event ticket stored in event ticket collection module 312, such that a user may view the current status and review the history of the event ticket. Event ticket view UI 500 may be presented to a user in response to selecting an event ticket listed in event ticket list UI 400 described above. As illustrated in the example of FIGS. 5-7, event ticket view UI 500 may include, but is not limited to, an identifier area 502, information area 504, and display area 506. The data in identifier area 502 may be the unique identifier as described in regard to the example of FIG. 3. In addition, the data in information area 502 may be the status of the event ticket as described in regard to the example of FIG. 3, as well as the start, end, creation and update information described in regard to FIG. 4. In some embodiments, data in identifier area 502 or information area 504 may edited through an inline text edit mode. In some embodiments, display area 506 may include an activity log tab 508, packages tab 510, and sensor time slice tab 512. Display area 506 may display data entries that correspond to the event ticket identified in identifier area 502, such as for example the personnel for the event ticket, time and date information when activity regarding the event was performed, or any associated comments of the activity.

Event ticket view UI 500 may also include, but is not limited to, a search field 420 and close event button 514. In some embodiments, event ticket view UI 500 may highlight text with at least a portion of text in display area 506 that corresponds to text input into search field 420. Clicking close event button 514 may change the status of the event ticket identified in identifier area 502 to closed status and disabling the ability to modify any data associated with the event ticket (e.g., “read-only” mode). Although this disclosure describes and illustrates an exemplary GUI with an exemplary graphical layout for displaying event tickets having exemplary data, this disclosure contemplates any suitable GUI with any suitable graphical layout for displaying event tickets having any suitable data.

As illustrated in the example of FIG. 5, event ticket view UI 500 may display data associated with activity taken with regard to the event ticket referenced in identifier area 502. In some embodiments, the activity data may be displayed in display area 506 in response to selecting or clicking activity log tab 508. As an example, selecting packages tab 510 may display data in display area 506 that identifies a date and time an activity was performed, the operator who performed the activity, and any comments associated with the activity. As illustrated in the example of FIG. 5, event ticket view UI 500 may display data associated with activity taken with regard to the particular event ticket referenced in identifier area 502. In some embodiments, event ticket view UI 500 may include an add log field 516 in response to selecting or clicking activity log tab 508. Add log area 516 may include a graphical element, such as for example a button, to allow an operator to add further information to comments associated with the activity. For example, a modal window for adding text may be displayed in response to clicking on the button in add log area 516.

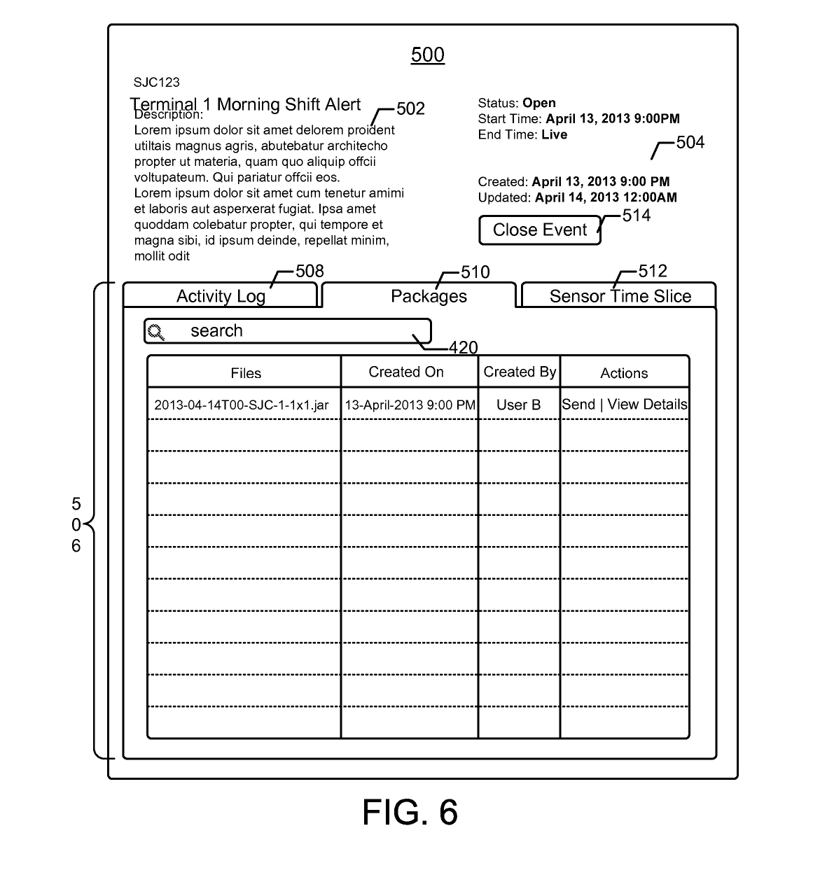

As illustrated in the example of FIG. 6, event ticket view UI 500 may display data associated with adjudication packages generated with regard to the event ticket referenced in identifier area 502. As described above, an adjudication package is a software collection of data or files of information associated with an event. In some embodiments, the data or files may include data associated with the activity log tab 508 and sensor time slice tab 512 described below. Furthermore, an adjudication package may include readings from sensors 110-114 associated with an event and data of sensors 110-114, as described above. As an example, the adjudication packages may be sent to a particular third-party of the entity responsible for managing the event ticket for further analysis through e-mail. As another example, personnel responsible for managing the event ticket may receive a secure link to download one or more adjudication packages. As illustrated in the example of FIG. 5, event ticket view UI 500 may display data associated with activity taken with regard to adjudication packages generated in regard to the event ticket referenced in identifier area 502. In some embodiments, the data associated with the generated adjudication packages may be displayed in display area 504 in response to selecting or clicking packages tab 510. As an example, selecting packages tab 510 may display data in display area 504 that identifies the generated adjudication packages, the date the adjudication packages were generated, the operator who generated each adjudication package, or actions that may be taken with regard to each adjudication package. In some embodiments, the data identifying the generated adjudication packages may include an embedded link to download an adjudication package. In some embodiments, the actions that may be taken with regard to each adjudication package may include sending the adjudication package or viewing particular details associated with the adjudication package, such as parameters used to generate the adjudication package or a list of recipients who have already received the adjudication package.

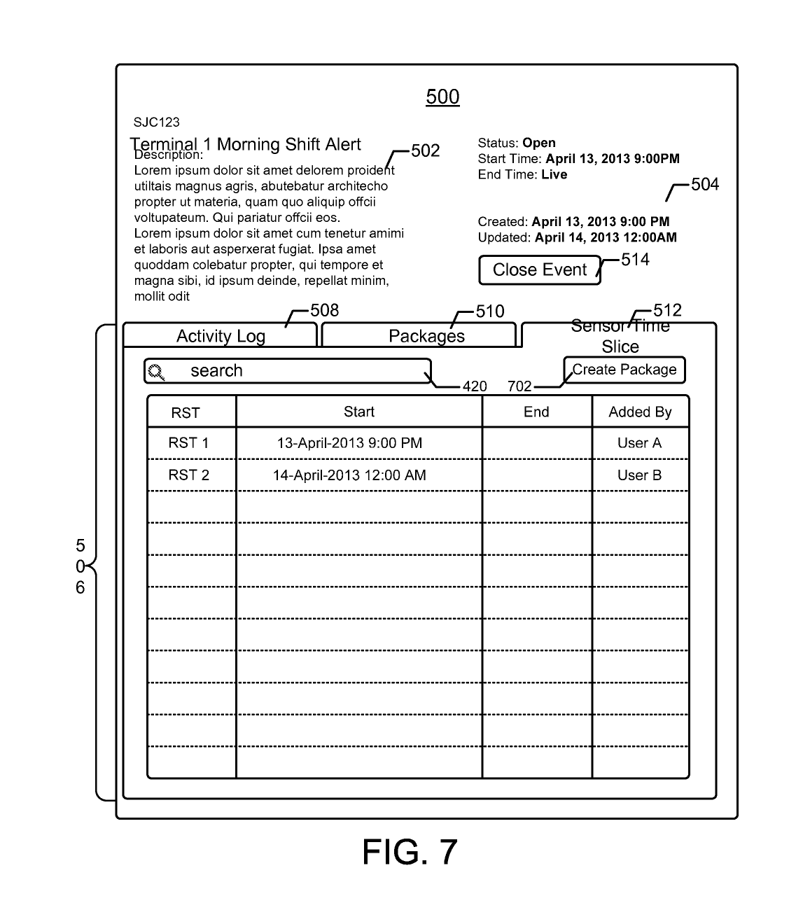

As illustrated in the example of FIG. 7, event ticket view UI 500 may display data associated with sensors 110-114 associated with the particular event ticket referenced in identifier area 502. In some embodiments, the data of sensors 110-114 associated with the particular event ticket may be displayed in display area 506 in response to selecting or clicking sensors time slice tab 512. As an example, selecting packages tab 510 may display data in display area 504 that identifies sensors 110-114 associated with the event ticket, the start time or date sensor 110-114 transmitted data relevant to the event, the end time or date sensor 110-114 transmitted data relevant to the event, and the operator who added sensor 110-114 to the event ticket. In some embodiments, event ticket view UI 500 may include a create package area 702 in response to selecting or clicking sensors time tab 512. Create log button 702 to allow an operator to initiate a process to generate an adjudication package based at least in part on sensors 110-114 identified in display area 506 and data of information area 504.

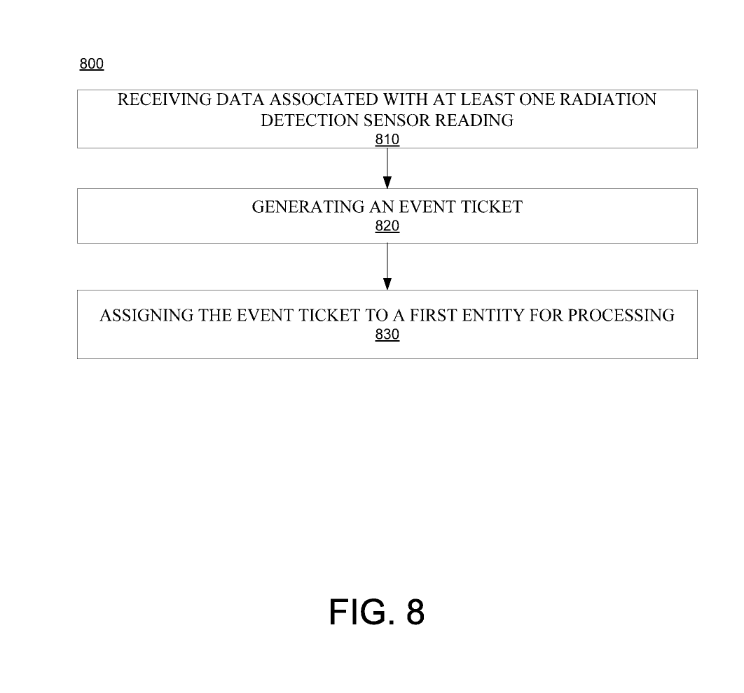

FIG. 8 illustrates one exemplary flow chart overview 800 to manage an event ticket according to some embodiments. At step 810, data associated with at least one radiation detection sensor reading is received. As illustrated in the example of FIG. 2, sensor based detection system 102 may receive data from sensors 110-114 through network 160. At step 820, an event ticket is generated in response to the received data satisfying a certain condition. As described above, event ticket module 310 may generate an event ticket based on reading from sensors 110-114. At step 830, the event ticket is assigned to a first entity for processing. As described above, an analytic process of event ticket module 310 may assigned the event ticket based on values of the sensor data or the time pendency of the event ticket.

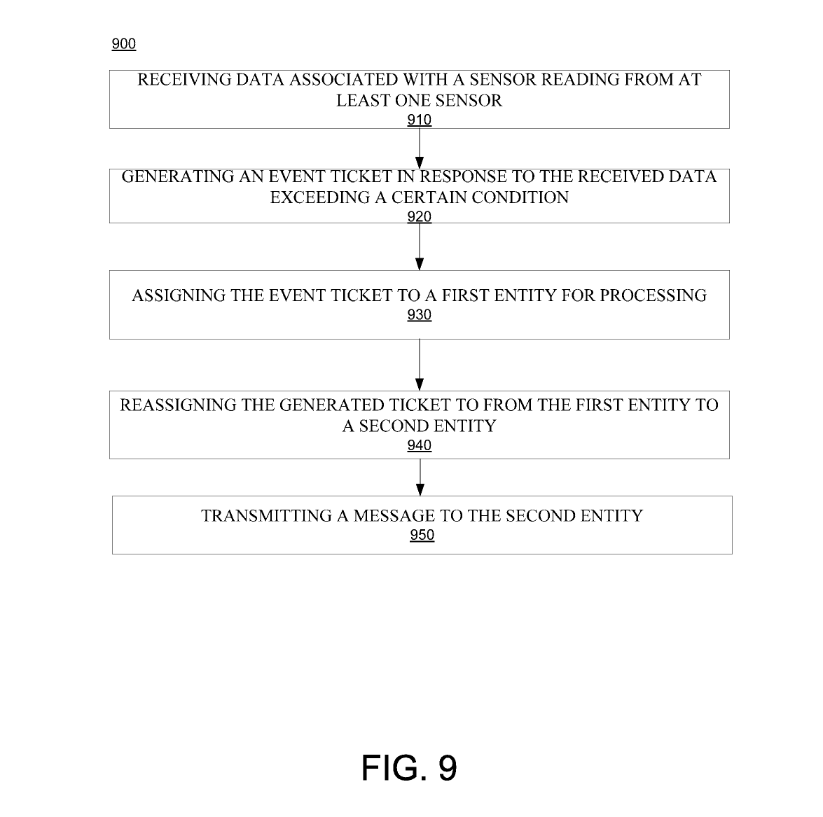

FIG. 9 illustrates another exemplary flow chart overview 900 to manage an event ticket according to some embodiments. At step 910, data associated with a sensor reading is received from at least one sensor. As illustrated in the example of FIG. 2, sensor based detection system 102 may receive data from sensors 110-114 through network 160. At step 920, an event ticket is generated in response to the received data exceeding a certain condition. For example, event ticket module 310 may determine readings from sensors 110-114 exceed a certain range and generate an event ticket. In one instance, the event ticket generated by event ticket module 310 includes information associated with an event ticket identifier, sensor data, status of the event ticket, or any combination thereof. At step 930, the event ticket is assigned to a first entity for processing. At step 940, based on a pendency of the generated event ticket and further based on actions taken with respect to the generated event ticket, the generated event ticket is reassigned to a second entity. Event ticket module 310 may escalate the status of the event ticket based on increasing readings from sensors 110-114. At step 950, a message is transmitted to the second entity indicating that the generated event ticket is awaiting for processing.

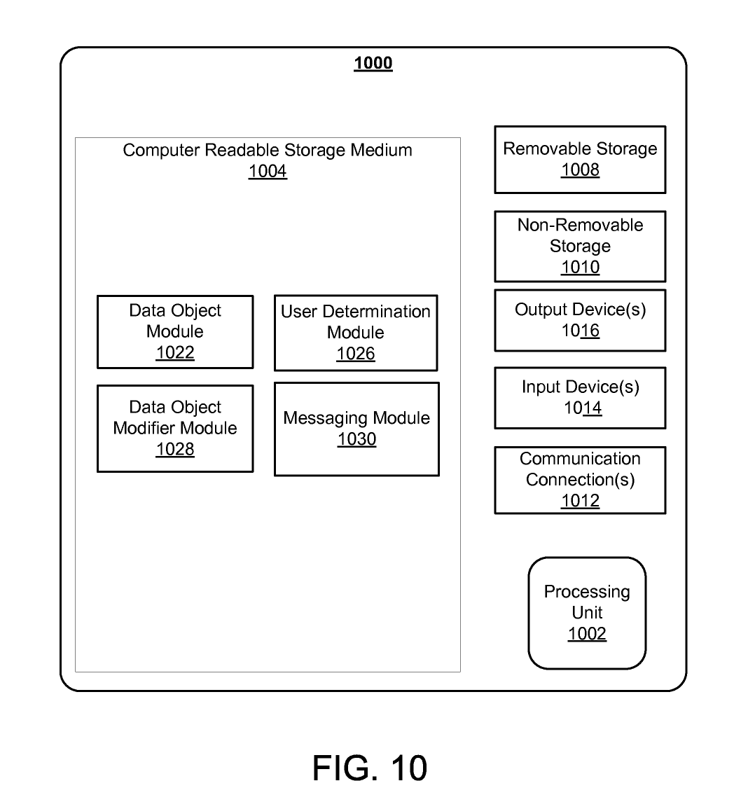

FIG. 10 illustrates an exemplary computer system, according to one embodiment. As illustrated in the example of FIG. 10, an exemplary system module for implementing embodiments includes a general purpose computing system environment, such as computing system environment 1000. Computing system environment 1000 may include, but is not limited to, servers, switches, routers, desktop computers, laptops, tablets, mobile devices, and smartphones. In its most basic configuration, computing system environment 1000 typically includes at least one processing unit 1002 and computer readable storage medium 1004. Depending on the exact configuration and type of computing system environment, computer readable storage medium 1004 may be volatile (such as RAM), non-volatile (such as ROM, flash memory, etc.) or some combination of the two. Portions of computer readable storage medium 1004 when executed manage an event ticket (e.g., processes 800 and 900).

Additionally, in various embodiments, computing system environment 1000 may also have other features/functionality. For example, computing system environment 1000 may also include additional storage (removable and/or non-removable) including, but not limited to, magnetic or optical disks or tape. Such additional storage is illustrated by removable storage 1008 and non-removable storage 1010. Computer storage media includes volatile and nonvolatile, removable and non-removable media implemented in any method or technology for storage of information such as computer readable instructions, data structures, program modules or other data. Computer readable medium 1004, removable storage 1008 and nonremovable storage 1010 are all examples of computer storage media. Computer storage media includes, but is not limited to, RAM, ROM, EEPROM, flash memory or other memory technology, expandable memory (e.g., USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 1000. Any such computer storage media may be part of computing system environment 1000.

In some embodiments, computing system environment 1000 may also contain communications connection(s) 1012 that allow it to communicate with other devices. Communications connection(s) 1012 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 1012 may allow computing system environment 1000 to communicate over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 1012 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 1000 may also have input device(s) 1014 such as keyboard, mouse, a terminal or terminal emulator (either connected or remotely accessible via telnet, SSH, http, SSL, etc.), pen, voice input device, touch input device, remote control, etc. Output device(s) 1016 such as a display, a terminal or terminal emulator (either connected or remotely accessible via telnet, SSH, http, SSL, etc.), speakers, light emitting diodes (LEDs), etc. may also be included. All these devices are well known in the art and are not discussed at length.

In one embodiment, computer readable storage medium 1004 includes a data object module 1022, a user determination module 1026, a data object modifier module 1028, and a messaging module 1030. The data object module 1022 is operable to access a data object according to flow diagrams 800 and 900, for instance. The user determination module 1026 may be used to determine a first user associated with the data object. The data object modifier module 1028 operates to modify a portion of the data to indicate the association between the first user and the data object, as discussed with respect to flows 800 and 900. The messaging module 1030 is operable to transmit a notification to the first user, as discussed with respect to flows 800 and 900. In some embodiments, messaging module 1030 is the messaging module 108 illustrated in the example of FIGS. 1 and 2.

It is appreciated that implementations according to embodiments of the present invention that are described with respect to a computer system are merely exemplary and not intended to limit the scope of the present invention. For example, embodiments of the present invention may be implemented on devices such as switches and routers, which may contain application specific integrated circuits (ASICs), field programmable gate arrays (FPGAs), etc. It is appreciated that these devices may include a computer readable medium for storing instructions for implementing methods according to flow diagram 800.

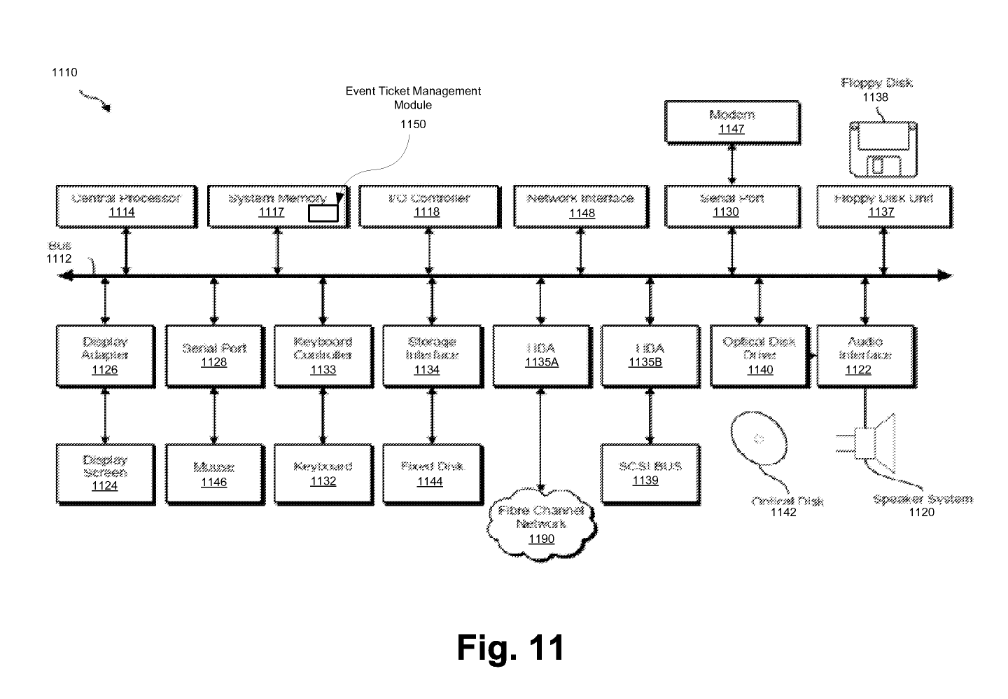

FIG. 11 illustrates a block diagram of another exemplary computer system, according to some embodiments. FIG. 11 depicts a block diagram of a computer system 1110 suitable for implementing the present disclosure. Computer system 1110 includes a bus 1112 which interconnects major subsystems of computer system 1110, such as a central processor 1114, a system memory 1117 (typically RAM, but which may also include ROM, flash RAM, or the like), an input/output controller 1118, an external audio device, such as a speaker system 1120 via an audio output interface 1122, an external device, such as a display screen 1124 via display adapter 1126, serial ports 1128 and 1130, a keyboard 1132 (interfaced with a keyboard controller 1133), a storage interface 1134, a floppy disk drive 1137 operative to receive a floppy disk 1138, a host bus adapter (HBA) interface card 1135A operative to connect with a Fibre Channel network 1190, a host bus adapter (HBA) interface card 1135B operative to connect to a SCSI bus 1139, and an optical disk drive 1140 operative to receive an optical disk 1142. Also included are a mouse 1146 (or other point-and-click device, coupled to bus 1112 via serial port 1128), a modem 1147 (coupled to bus 1112 via serial port 1130), and a network interface 1148 (coupled directly to bus 1112). It is appreciated that the network interface 1148 may include one or more Ethernet ports, wireless local area network (WLAN) interfaces, etc., but are not limited thereto. System memory 1117 includes a hierarchy generator and traffic flow module 1150 which is operable to construct a hierarchical network and to further update traffic flows in response to a topology change within the hierarchical network. According to one embodiment, the event ticket management module 1150 may include other modules for carrying out various tasks. For example, event ticket management module 1150 may include the data object module 922, the user determination module 926, the data object modifier module 928, and the messaging module 930, as discussed with respect to FIG. 9 above. It is appreciated that the event ticket management module 1150 may be located anywhere in the system and is not limited to the system memory 1117. As such, residing of the event ticket management module 1150 within the system memory 1117 is merely exemplary and not intended to limit the scope of the present invention. For example, parts of the event ticket management module 1150 may reside within the central processor 1114 and/or the network interface 1148 but are not limited thereto.

Bus 1112 allows data communication between central processor 1114 and system memory 1117, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 1110 are generally stored on and accessed via a computer readable medium, such as a hard disk drive (e.g., fixed disk 1144), an optical drive (e.g., optical drive 1140), a floppy disk unit 1137, or other storage medium. Additionally, applications can be in the form of electronic signals modulated in accordance with the application and data communication technology when accessed via network modem 1147 or interface 1148.

Storage interface 1134, as with the other storage interfaces of computer system 1110, can connect to a standard computer readable medium for storage and/or retrieval of information, such as a fixed disk drive 1144. Fixed disk drive 1144 may be a part of computer system 1110 or may be separate and accessed through other interface systems. Network interface 1148 may provide multiple connections to other devices. Furthermore, modem 1147 may provide a direct connection to a remote server via a telephone link or to the Internet via an internet service provider (ISP). Network interface 1148 may provide one or more connection to a data network, which may include any number of networked devices. It is appreciated that the connections via the network interface 1148 may be via a direct connection to a remote server via a direct network link to the Internet via a POP (point of presence). Network interface 1148 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 11 need not be present to practice the present disclosure. The devices and subsystems can be interconnected in different ways from that shown in FIG. 11. The operation of a computer system such as that shown in FIG. 11 is readily known in the art and is not discussed in detail in this application. Code to implement the present disclosure can be stored in computer-readable storage media such as one or more of system memory 1117, fixed disk 1144, optical disk 1142, or floppy disk 1138. The operating system provided on computer system 1110 may be MS-DOS®, MS-WINDOWS®, OS/2®, UNIX®, LINUX®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. A method comprising:
receiving data associated with at least one radiation detection sensor reading;
in response to the received data satisfying a certain condition, generating an event ticket; and
assigning the event ticket to a first entity for processing.

2. The method as described in claim 1 further comprising:
determining whether the received data satisfies the certain condition.

3. The method as described in claim 1, wherein the certain condition is whether the received data is within a certain range.

4. The method as described in claim 1 further comprising:
receiving data associated with the at least one radiation sensor, wherein the event ticket includes the received data.

5. The method as described in claim 4, wherein the data associated with the least one radiation sensor includes latitude information and longitude information associated with a location of the at least one radiation detection sensor.

6. The method as described in claim 1 further comprising:
tracking an elapsed time that a status indicator associated with the event ticket is incomplete; and
responsive to the elapsed time exceeding an acceptable elapsed time, escalating the event ticket for further processing.

7. The method as described in claim 1 further comprising:
transmitting a message to the first entity indicating that the generated event ticket is awaiting for processing.

8. The method as described in claim 1, wherein the event ticket comprises information associated with an event ticket identifier, sensor data, status of the event ticket, or any combination thereof.

9. The method as described in claim 1, further comprising:
tracking pendency of the generated event ticket;
tracking actions taken associated with the generated event ticket; and
assigning the generated ticket to a second entity based on a pendency of the generated event ticket and further based on the actions taken.

10. A system comprising:
an event module configured to generate an event based on alerts associated with one more radiation detection sensor reading;
an event ticket module configured to receive the generated event, wherein the event ticket module is further configured to generate an event ticket responsive to the event satisfying a certain condition, and wherein the event ticket module is further configured to assign the generated event ticket to an appropriate entity for processing; and
an event ticket collection module configured to receive and store the generated event ticket for later retrieval.

11. The system as described in claim 10, wherein the event ticket module is further configure to determine whether the received data is within a certain range.

12. The system as described in claim 10, further comprising:
a sensor time slice collection module configured to receive data associated with the at least one radiation sensor, wherein the event ticket includes the received data.

13. The method as described in claim 12, wherein the data associated with the least one radiation sensor includes latitude information and longitude information associated with a location of the at least one radiation detection sensor.

14. The system as described in claim 10, wherein the event ticket module is further configured to:
track an elapsed time that a status indicator associated with the event ticket is incomplete; and
in response to the elapsed time exceeding an acceptable elapsed time, escalate the event ticket for further processing.

15. The system as described in claim 10, further comprising:
a messaging module configured to transmit a message to the first entity indicating that the generated event ticket is awaiting for processing.

16. The system as described in claim 10, wherein the event ticket module is further configured to:
track pendency of the generated event ticket;
track actions taken associated with the generated event ticket; and
assign the generated ticket to a second entity based on a pendency of the generated event ticket and further based on the actions taken.

17. A method comprising:
receiving data associated with a sensor reading from at least one sensor;
generating an event ticket in response to the received data exceeding a certain condition, wherein the event ticket comprises information associated with an event ticket identifier, sensor data, status of the event ticket, or any combination thereof;
assigning the event ticket to a first entity for processing;
reassigning the generated ticket from the first entity to a second entity based on a pendency of the generated event ticket or on actions taken with respect to the generated event ticket; and
transmitting a message to the second entity indicating that the generated event ticket is awaiting for processing.

18. The method as described in claim 18, wherein the received data is information selected from a group consisting of thermal, electromagnetic, light, image, particle, Geiger counter, mechanical, biological, and chemical.

19. The method as described in claim 17, further comprising:
tracking the pendency of the generated event ticket; and
tracking actions taken associated with the generated event ticket.

20. The method as described in claim 17, further comprising:
tracking an elapsed time that a status indicator associated with the generated event ticket is incomplete; and
responsive to the elapsed time exceeding an acceptable elapsed time, escalating the generated event ticket for further processing.

21. The method as described in claim 17, further comprising:
determining whether the received data exceeds a certain range.
